(19) United States
(12) Patent Application Publication
(10) Pub. No.: US 2011/0285285 A1
(43) Pub. Date: Nov. 24, 2011

(54) MECHANICAL TURNPLATE TYPE ROTATABLY DIMMING DEVICE AND DIMMING METHOD THEREOF

(75) Inventor: Liang Cen, Shenzhen (CN)

(73) Assignee: SHENZHEN LANGHENG ELECTRICAL CO., LTD., Shenzhen, Guandong (CN)

(21) Appl. No.: 13/147,028

(22) PCT Filed: Dec. 5, 2009
(86) PCT No.: PCT/CN2009/075335

§ 371 Date: Jul. 29, 2011

(30) Foreign Application Priority Data
Mar. 20, 2009 (CN) 200920135798.5

(51) Int. Cl. H05B 37/02; H05B 33/08

(52) U.S. Cl. 315/33; 315/51

(57) ABSTRACT

A mechanical turnplate type rotatably dimming device has a bottom part (1) and a front part (7) of a lamp holder, which form a cavity for holding a dimming part. The dimming part comprises a PCB (5) with potentials, an electric brush (4), a transmission unit (3) and another end is elastically contacted with the potential region of the PCB (5). The transmission unit (5) is buckled with the turnplate (25).

### FIELD OF THE INVENTION

This invention relates to flashlights, and more particularly to switches for controlling flashlight output. This invention also relates to a method for providing a 360 degree revolving ring-switch for precision output selection.

### BACKGROUND OF THE INVENTION

LED flashlights typically have a battery in a cylinder. An LED socket is provided at the front end of the cylinder, the output of the LED is controlled by pressing a push button on the cylinder for turning the flashlight on and off. Since a press switch must be added on the cylinder; the cost of production for flashlights and the complexity of their operation is increased.

It is widely known in the field of multifunctional portable lighting devices to produce electric current by using magnetic induction elements and/or magnets, but such magnetic induction elements cannot prevent magnetic induction from magnetic interference and cause defect. It is also known to to control the output of the flashlight by relative rotation of a cover or a cylinder. However, such rotation typically utilizes rotation along a screw thread on a cover and/or the cylinder, such rotation may cause abrasive damage and the thread may become fouled easily.

Therefore, the existing operation of a conventional LED flashlight cannot satisfy the requirement for precise output selecting. It is necessary to provide a novel structure to overcome the defects of the conventional technique.

### SUMMARY OF THE INVENTION

An object of the present invention is to provide a durable mechanical revolving dimmer system for selection of output modes.

A second object of the present invention is to provide a method which can select output with precision via a 360 degree revolving ring-switch.

In order to achieve the above objects, the present invention provides a Mechanical Ring-Switch, having a lamp holder and a lamp base, said lamp holder and lamp base enclosed in a housing with a dimmer system in it, characterized in that, said dimmer system comprises a PCB with contact element, an electrical brush, a ring, and a gearing device which may be rotated by turning said ring, said gearing device comprising 3 toothed gears, named gear A, gear B, and gear C, said gear A having a lock joint connected to said ring, said gear C connected to said electrical brush by ironing; Said PCB's contact element is divided into several parts, each part connected to different sampling output terminal, and each sampling output terminal connected to different circuit. One end of said electrical brush is fixed on the gearing device and the other end of said electrical brush elastically contacts a part of said PCB's contact element.

Said sampling output terminal comprises a sampling output mode terminal and a sampling brightness output terminal, said sampling output mode terminal actuates different electrical circuits by sampling different controlling signals of the selected output mode, and said sampling brightness output terminal actuates different electrical circuits causing different brightness depending upon the selected electrical circuit.

Said sampling output mode terminal is the sampling output mode terminal of a Microcontroller Unit, and said sampling brightness output terminal is a sampling resistance output terminal, which actuates different electrical circuits causing a different light level by sampling a different voltage signal.

Said ring is connected to the body of the flashlight by a ball-and-socket connection allowing the ring to be rotated through a range of angular positions, said ball-and-socket connection including a set of cavities located on the inner surface of ring, therefore, a set of the sockets located on the point of the connection between said lamp holder and said ring, and each socket has a spring, a ball, and a ball cap in it, the protrusion of the ball fastened to the inner surface of said ring.

Said PCB with contact element has a controlling circuit on it, and the contact element is circular. Said roundish contact element is divided into a 12 part contact area, each contact area formed as a 30 degree flabelliform arc area, and each flabelliform arc area matches a different sampling output mode terminal or different sampling brightness output terminal.

There are two additional PCBs connected to said PCB with contact element, one is a cross PCB with drive circuit, the other is a PCB used for connecting battery, therefore, one end of said cross PCB connects said PCB with contact element by insertion into a fixing aperture of the PCB with contact element, and the other end of said cross PCB connects to said PCB used for connecting battery by inserting into a fixing aperture of the PCB for connecting battery.

Said mechanical Ring-switch can be installed in a lamp holder.

A method for precise output selecting by mechanical Ring-switch, is characterized in that, the brightness is adjusted by an electrical brush fastened on the contact element of a PCB which is connected to different electrical circuit, wherein, said contact element is divided into several part contact areas, each part contact area corresponding to a different sampling output terminal, each sampling output terminal connected to a different electrical circuit, and, said electrical brush is actuated by rotation of a mechanical ring, the power of said mechanical ring is transmitted to said electrical brush by a gearing device, said gearing device provided with a gear A, a gear B, and a gear C, said gear A having a lock joint which connects to said ring; said gear B coupling rotation of said gear A to said gear C; said gear C connected to said electrical brush by ironing. said PCB's contact element is divided into several parts, each part connected to a different sampling output terminal, and each sampling output terminal connected to a different circuit; therefore, one end of said electrical brush is fixed on the gearing device, the other end of said electrical brush is elastically connected to one part of said PCB's contact element.

Said PCB has a controlling circuit on it, and the contact element is generally circular.

Said sampling output terminal includes a sampling output mode terminal and a sampling brightness output terminal, said sampling output mode terminal actuates different electrical circuits by sampling different output mode controlling signals, and said sampling brightness output terminal actuates different electrical circuits causing different brightness by sampling different signals. Said sampling output mode terminal is the sampling output mode terminal of the Microcontroller unit, and said sampling brightness output terminal is the sampling resistance output terminal, which actuates different electrical circuits causing different light levels by sampling different voltage signals.

Said PCB has a controlling circuit on it, and the contact element is circular, said circular contact element is divided into 12 part contact areas, each area has a 30 degree flabelliform arc area, and each flabelliform arc area corresponds to a different sampling output mode terminal or different sampling brightness output terminal.

Preferably, said sampling resistance output terminal consists of 4 modes of output, which are optical flash mode, SOS mode, strobe mode, and light mode.

According to the invention, an advantage of the mechanical ring-switch is the special electrical brush which is fixed on the gearing device, which could be connected to one part of said contact element of said PCB elastically, causing the lamp to be connected to a different electrical circuit, which could thereby adjust modes and brightness of output by mechanical coupling. As a result, the ring-switch could prevent magnetic interference.

In addition to this, since the transmit device according to the invention is the gearing device, the resulting structure has significant characteristics and advantages such as strong shock resistance, and water resistance.

Further advantages of the invention are characterized in the method for adjusting Output by mechanical Ring-switch, dividing the contact element of the PCB into 12 contact areas, each area matching a different sampling output terminal, each sampling output terminal connected to a different circuit. Since said electrical brush is actuated by rotation of the mechanical Ring-switch, the invention utilizes the mechanical revolving dimmer system for precisely selecting its 12 output modes, which offer the flashlight better operation and more precision in output selection compare with other revolving dimmers.

### BRIEF DESCRIPTION OF THE DRAWINGS

FIG. 1 illustrates the structure of the Ring-switch,

FIG. 2 illustrates the structure of the dimmer system,

FIG. 3 illustrates the structure of the gearing device,

FIG. 4 illustrates the structure of the PCB with contact element,

FIG. 5 illustrates the contact circuit of said circular PCB,

FIG. 6 illustrates the controlling circuit of the circular PCB.

### DETAILED DESCRIPTION OF THE ILLUSTRATIVE EMBODIMENT

In the drawings: 1. lamp holder; 2. dimmer system; 21. ball; 22. ball cap; 23. spring; 24. socket; 25. ring; 3. gearing device; 31. Gear A; 32. Gear B; 33. Gear C; 311. lock joint; 4. electrical brush; 5. PCB; 51. roundish PCB; 511. GND; 512. MCU sampling output terminal; 513. sampling resistance output terminal; 52. cross-shaped PCB; 53. battery connecting PCB; 7. Lamp base.

### DETAILED DESCRIPTION OF THE INVENTION ACCORDING TO THE ATTACHED DRAWINGS

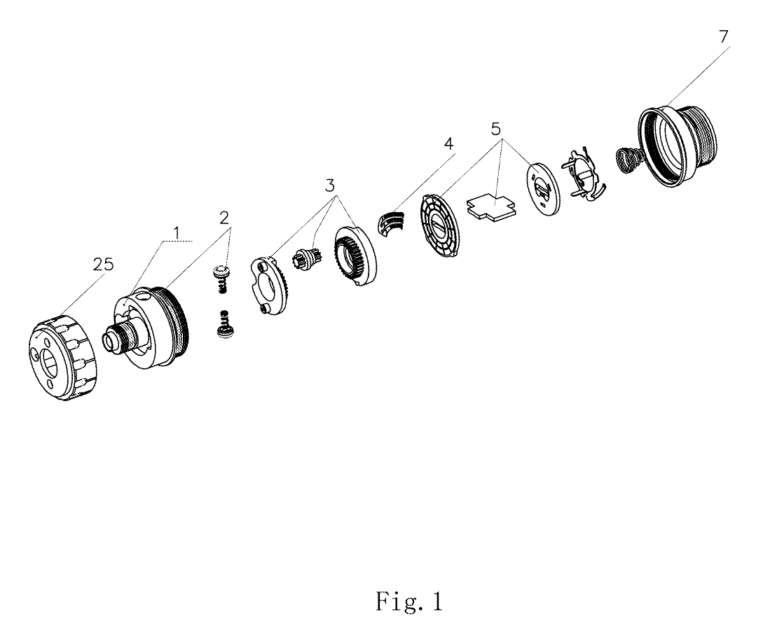

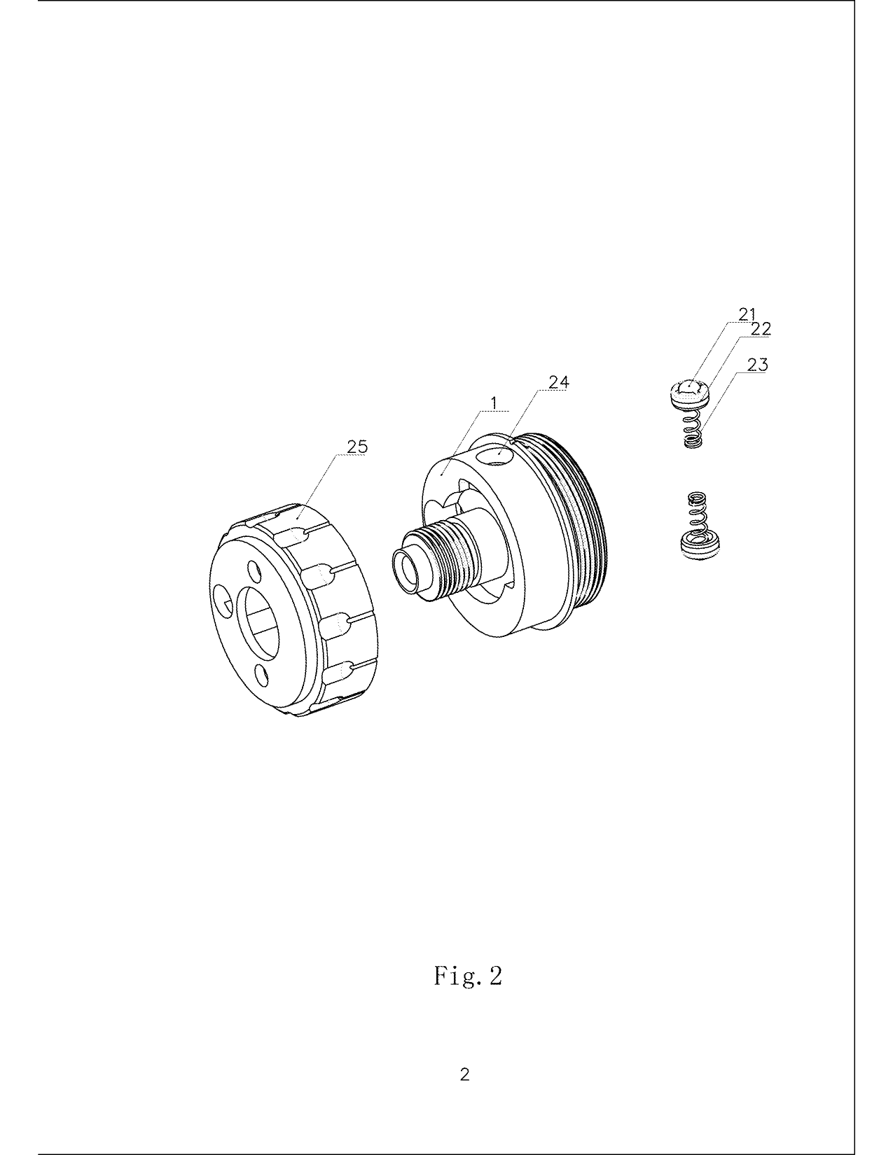

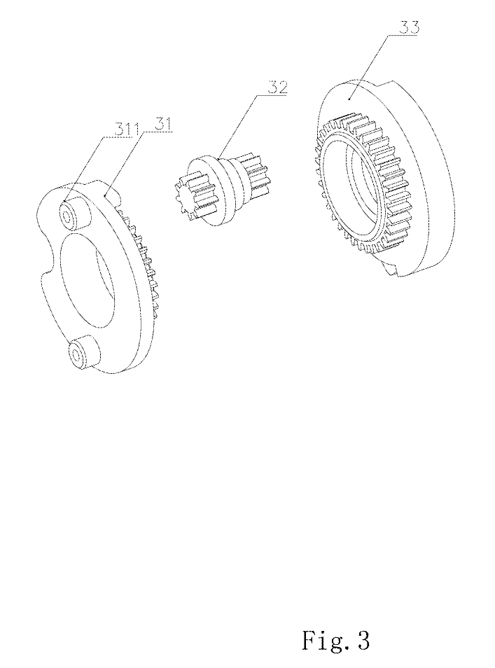

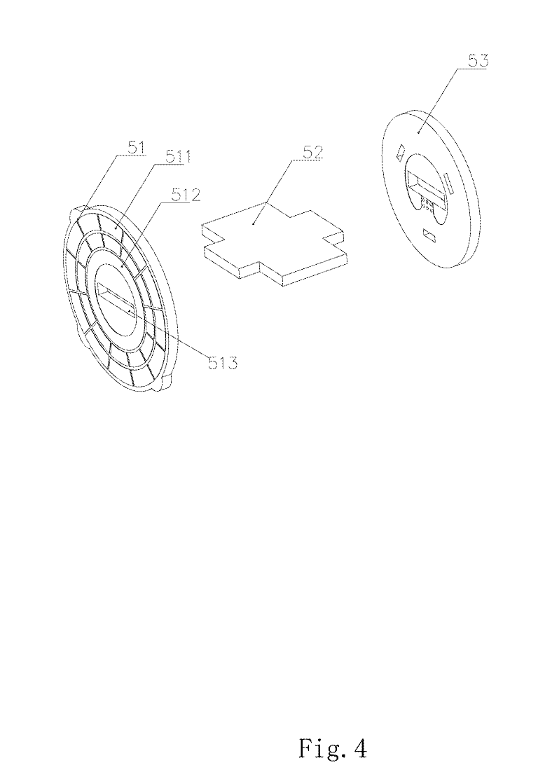

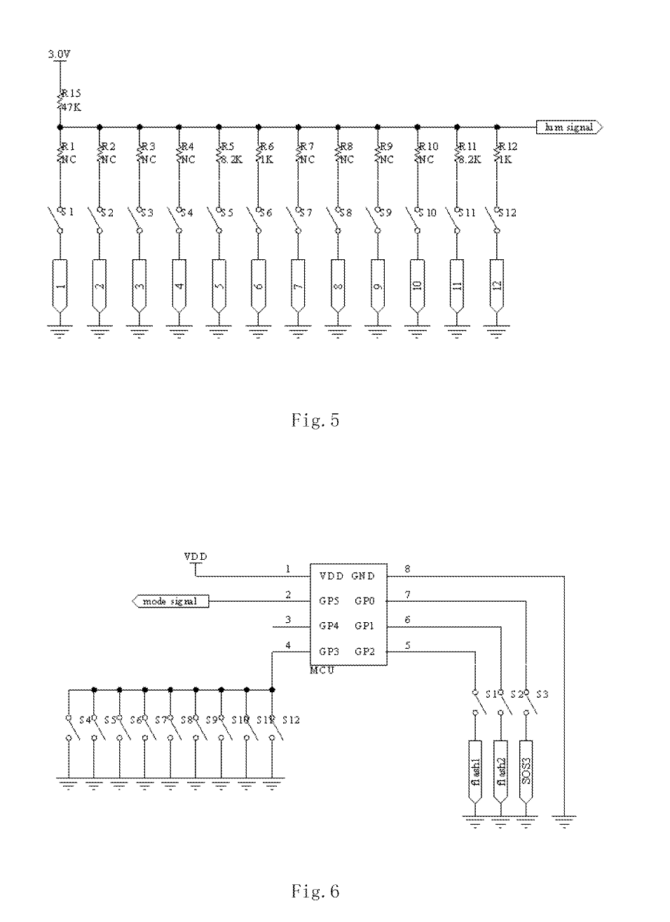

Example 1, referring to FIG. 1, FIG. 2, FIG. 3, FIG. 4, FIG. 5 and FIG. 6, a mechanical ring-switch, having a lamp holder (1) and a lamp base (7), said lamp holder (1) and lamp base (7) enclosed in a housing with a dimmer system (2) in it, said dimmer system (2) comprising a PCB (5) with contact element, an electrical brush (4), a ring (25), and a gearing device (3) which is rotatable by turning said ring (25). Said gearing device (3) consists of 3 toothed gears: a gear A (31), a gear B (32), and a gear C (33), said gear A (31) having a lock joint (311) connected to said ring (25), said gear C (33) connected to said electrical brush (4) by ironing. Said PCB's contact element is divided into several parts, each part connected to a different sampling output terminal, and each sampling output terminal connected to a different electrical circuit; therefore, one end of said electrical brush is connected to the gearing device, the other end of said electrical brush is elastically connected to one part of said PCB's contact element.

Said sampling output terminal consists of a sampling output mode terminal and a sampling brightness output terminal, said sampling output mode terminal actuates different electrical circuits by sampling different output mode controlling signals, and said sampling brightness output terminal actuates different electrical circuits causing different brightness by sampling different signals.

Said sampling output mode terminal is the sampling output mode terminal of Microcontroller Unit (512), and said sampling brightness output terminal is sampling resistance output terminal (513), which actuates different electrical circuits causing different light levels by sampling different voltage signals.

Said ring is connected to the body of the flashlight by a ball-and-socket connection allowing the ring to be rotated through a range of angular positions, said ball-and-socket connection including a set of cavities located on the inner surface of ring, therefore, a set of socket (24) located on the point of the connection between said lamp holder and said ring, and each socket has a spring (23), a ball (21), and a ball cap (22) in it, the protrusion of the ball fastened to the inner surface of said ring.

Referring to FIG. 6, said PCB with contact element has a controlling circuit on it, and the contact element is circular. Said circular contact element is divided into 12 contact areas, each area has a 30 degree flabelliform arc area, and each flabelliform arc area corresponds to a different sampling output mode terminal or different sampling brightness output terminal.

There are additional 2 PCBs connected to said PCB with contact element, one is a cross PCB (52) with drive circuit, the other is a battery connecting PCB (53) used for connecting battery, therefore, one end of said cross PCB connect said PCB with contact element by inserting the fixing aperture, and the other end of said cross PCB connect said PCB used for connecting battery by inserting the fixing aperture either.

Example 1, Since the electrical brush (4) is connected to said gear C (33) by ironing, it will actuate by rotation of the said gear C (33), while said gear C (33) will actuate by rotation of said gear B and gear A, which will actuate by turning the ring (25). The contact element of said PCB is circular, and said contact element is divided into 12 part contact areas, each area has a 30 degree flabelliform arc area, and each flabelliform arc area corresponds to a different MCU sampling output terminal and different sampling resistance brightness output terminal, each MCU sampling output terminal (512) and sampling resistance brightness output terminal (513) is connected to different circuit. Therefore, said electrical brush (4) fixed on the gearing device (3), and connected to one area of said contact element of said PCB (51) elastically, driving a different circuit of the lamp. Therefore, when turning the ring 30 degree, the flabelliform arc area which the electrical brush (4) is connected to will change, causing the circuit of the lamp change too, then the output of the lamp will be adjusted.

Example 2, said mechanical Ring-switch can be installed in a lamp holder.

In a method for precise output selecting by mechanical ring-switch, the brightness may be adjusted by an electrical brush which is fastened on the contact element of a PCB which connected to a different circuit, wherein, said contact element is divided into several part contact areas, each area matches a different sampling output terminal, each sampling output terminal connected to a different circuit, and, said electrical brush is actuated by rotation of an mechanical ring. The rotation of said mechanical ring is transmitted to said electrical brush by a gearing device, said gearing device consists of 3 toothed gears: a gear A, a gear B, and a gear C, said gear A having a lock joint which is connected to said ring; said gear B coupling rotation of said gear A to said gear C; said gear C connected to said electrical brush by ironing. Said PCB's contact element is divided into several parts, each part connected to different sampling output terminal, and each sampling output terminal connected to different circuit; therefore, one end of said electrical brush is connected to the gearing device, the other end of said electrical brush is elastically connected to one part of said PCB's contact element.

Said sampling output terminal consist of a sampling output mode terminal and a sampling brightness output terminal, said sampling output mode terminal actuate different electrical circuits by sampling different output mode controlling signals, and said sampling brightness output terminal actuate different electrical circuits causing different brightness by sampling different signals. Said sampling output mode terminal is the sampling output mode terminal of the Microcontroller unit, and said sampling brightness output terminal is a sampling resistance output terminal, which actuates different electrical circuits causing different light levels by sampling different voltage signals.

Said PCB has a controlling circuit on it, and the contact element is circular, said circular contact element is divided into 12 part contact area, each area has a 30 degree flabelliform arc area, and each flabelliform arc area corresponds to a different sampling output mode terminal or different sampling brightness output terminal.

Preferably, said sampling resistance output terminal consists of 4 modes of output, which are optical flash mode, SOS mode, strobe mode, and light mode.

1. A mechanical ring-switch, comprising:
a lamp holder and a lamp base; said lamp holder and said lamp base enclosed in a housing with a dimmer system in it, said dimmer system comprising:
a PCB with a contact element; an electrical brush, a ring, and a gearing device rotatable by turning said ring; said gearing device consists of, a gear A, a gear B, and a gear C, said gear A having a lock joint connected to said ring, said gear B coupling rotation of said gear A to said gear C;
said gear C connected to said electrical brush by ironing;
said contact element is divided into a plurality of parts, each of the parts connected to a different sampling output terminal, and each of the sampling output terminal is connected to a different electrical circuit.

2. The mechanical ring-switch of claim 1, wherein said sampling output terminal is a sampling output mode terminal and a sampling brightness output terminal, said sampling output mode terminal actuating a different electrical circuit by sampling a different output mode controlling signal, and said sampling brightness output terminal actuating a different electrical circuit to generate a desired brightness.

3. The mechanical ring-switch of claim 2, wherein said sampling output mode terminal is the sampling output mode terminal of a microcontroller unit, and said sampling brightness output terminal is a sampling resistance output terminal, which causes a different light level by creating a different voltage.

4. The mechanical ring-switch of claim 1, wherein said ring is connected to the body of the flashlight by a ball-and-socket connection allowing the ring to be rotated through a range of angular positions, said ball-and-socket connection including a plurality of cavities located on the inner surface of ring, therefore, a plurality of sockets located on the point of the connection between said lamp holder and said ring, and each socket has a spring, a ball, and a ball cap in it, the protrusion of the ball fastened the inner surface of said ring.

5. The mechanical ring-switch of claim 1, wherein said PCB has a controlling circuit on it, and the contact element is circular.

6. The mechanical Ring-switch of claim 5, wherein there are two additional PCBs connected to said PCB with contact element, one of the additional PCB is a cross PCB with drive circuit, the other additional PCB is a battery connecting PCB, whereby, one end of said cross PCB connects said PCB with contact element by insertion into a fixing aperture of the PCB with contact element, and the other end of said cross PCB connects said battery connecting by insertion into a fixing aperture of the battery connecting PCB.

7. The mechanical ring-switch of claim 5, wherein said roundish contact element is divided into 12 part contact areas, each area with a 30 degree flabelliform arc area, and each flabelliform arc area corresponding to a different sampling output mode terminal or different sampling brightness output terminal.

8. (canceled)

9. A method for precise output selecting by mechanical ring-switch, comprising the steps of: adjusting the brightness by an electrical brush fastened on the contact element of a PCB which connects to a different electrical circuit, wherein, said contact element is divided into several part contact areas, each area corresponding to a different sampling output terminal, each of the sampling output terminal connected to different circuit; and
said electrical brush is actuated by rotation of a mechanical ring, the power of said mechanical ring transmitted to said electrical brush by a gearing device, said gearing device having a gear A, a gear B, and a gear C; said gear A having a lock joint which connected to said ring, said gear B coupling rotation of said gear A to said gear C; said gear C connecting to said electrical brush by ironing;
said PCB's contact element is divided into several parts, each part connected to a different sampling output terminal, and each of the sampling output terminal connected to a different electrical circuit;
one end of said electrical brush is coupled to the gearing device, another end of said electrical brush is elastically connected to of the several parts of said PCB's contact element.

10. The method for precise output selecting by mechanical ring-switch of claim 9, wherein said PCB has a controlling circuit on it, and the contact element is circular.

11. The method for precise output selecting by mechanical ring-switch of claim 10, wherein said PCB has a controlling circuit on it, and the contact element is circular said contact element is divided into 12 part contact area, each area has 30 degree flabelliform arc area, and each arc area matches a different sampling output mode terminal or different sampling brightness output terminal.
